(19) United States
(12) Patent Application Publication
(10) Pub. No.: US 2023/0045084 A1
(43) Pub. Date: Feb. 9, 2023

(54) ENERGY DISTRIBUTION MANAGEMENT METHOD FOR DYNAMIC BROKERAGE OF RENEWABLE ENERGY, AND DYNAMIC BROKERAGE SYSTEM

(71) Applicant: ELECTRONICS AND TELECOMMUNICATION RESEARCH INSTITUTE, Daejeon (KR)

(72) Inventors: Yoon-Sik Yoo, Daejeon (KR); II Woo Lee, Daejeon (KR); Seung Wan Alex Kim, Daejeon (KR); Eo Jin Choi, Daejeon (KR)

(21) Appl. No.: 17/868,291

(22) Filed: Jul. 19, 2022

(30) Foreign Application Priority Data
Jul. 27, 2021 (KR) 10-2021-0098656
Feb. 14, 2022 (KR) 10-2022-0018829

(51) Int. Cl. G06Q 30/08; G06Q 50/06; G06Q 30/02

(52) U.S. Cl. CPC G06Q 30/08; G06Q 50/06; G06Q 30/0206; G06Q 30/0208

(57) ABSTRACT

Provided are an energy distribution management method and a dynamic brokerage system for dynamic brokerage of renewable energy. An energy distribution management method provides optimal profits according to dynamic brokerage by improving utility through optimal energy distribution according to a required amount of energy of a renewable energy consumer in uncertain supply and demand for renewable energy.

### CROSS-REFERENCE TO RELATED APPLICATIONS

This application claims the benefit of Korean Patent Application No. 10-2021-0098656 filed on Jul. 27, 2021, and Korean Patent Application No. 10-2022-0018829 filed on Feb. 14, 2022, in the Korean Intellectual Property Office, the entire disclosure of which are incorporated herein by reference for all purposes.

### BACKGROUND

### 1. Field of the Invention

One or more example embodiments relate to an energy distribution management method and a dynamic brokerage system, and more specifically, to a method and an apparatus for solving an issue on uncertainty in a dynamic brokerage mechanism of renewable energy among renewable energy prosumers for utility optimization trade between a renewable energy provider and a renewable energy consumer.

### 2. Description of the Related Art

Recently, owing to the passage of the Power Purchase Agreement (PPA) and related amendments to the Electric Utility Act, renewable energy providers supply electricity generated using renewable energy to electricity consumers without going through an electricity market. The amount of self-consumed electricity was excluded from the issuance of a renewable energy certificate (REC), limiting the efficient use of energy supply and demand. Especially, significance lies in solving the issue through the issuance of the renewable self-consumption credit (RSC), as the use of renewable energy cannot be recognized despite the consumption thereof.

Accordingly, a prosumer (renewable energy provider) sells the supply certificate (REC) and a system marginal price (SMP) for the amount of power that was not consumed by the prosumer while selling the REC for the amount consumed by oneself. Therefore, companies purchase the RSC so that the use of renewable energy is recognized, thereby activating infrastructure construction for supply and demand for new and renewable energy and Renewable Energy 100% (RE 100).

However, if the supply of new and renewable energy is insufficient, it is possible to supply energy to the renewable energy consumer by purchasing, from a power retailer, the sufficient amount of energy supplied from existing main grids. Recently, with an increase in the number of microgrids due to the spread of new and renewable energy, independent configuration is expanding, thereby increasing the number of cases concerning uncertain energy production within the microgrid as well as consumption and trade.

Therefore, it is necessary to construct a management infrastructure for optimal distribution of energy through dynamic brokerage for utility optimization trade in the supply and demand for new and renewable energy for energy trade.

### SUMMARY

Example embodiments provide an apparatus and a method for delivering energy optimized for distributed energy resources to be used by a demand resource and a load under an uncertain environment for new and renewable energy among renewable energy prosumers.

Example embodiments provide an apparatus and a method for trading renewable energy at an optimal cost and bringing utility enhancement, by purchasing an insufficient amount of energy through an electricity trading market to be sold to a renewable energy consumer when energy supply provided by a renewable energy provider falls short of an amount of energy required from the renewable energy consumer.

Example embodiments provide an apparatus and a method for providing efficiency in renewable energy to maximize satisfaction of energy brokers and renewable energy consumers by providing optimal profits in consideration of availability of a demand resource and a load for distributed energy resources.

According to an aspect, there is provided an energy distribution management method including receiving an energy transaction message regarding required energy from a renewable energy consumer (RES) and profiling the energy transaction message as history information, determining an amount of energy distribution distributable for each energy transaction message requesting required energy by analyzing the profiled history information, determining a brokerage fee for an energy trade between a renewable energy provider (REP) and the RES according to the amount of energy distribution, and when the energy trade is established at the brokerage fee, providing renewable energy to the RES by interconnecting the REP at the time of trading.

The profiling as the history information may include analyzing the energy transaction message from the RES to profile priority regarding supply of the renewable energy as the hi story information.

The determining of the amount of energy distribution may include determining the amount of energy distribution corresponding to the energy transaction message regarding a demand resource and a load for each RES.

The determining of the amount of energy distribution may include determining an amount of energy generation of the REP using generation information of distributed energy resources registered in an energy brokerage apparatus, and determining the distributable amount of energy distribution by comparing the amount of energy generation of the REP with an energy demand in the energy transaction message.

The determining of the brokerage fee may include determining the brokerage fee in consideration of a bidding cost and an available supply cost of a prosumer according to a volume of issuance of RSC for brokerage of the renewable energy.

The determining of the brokerage fee may include determining the brokerage fee for trading the required energy based on a usage amount of renewable energy consumed in each time slot of a time unit.

The providing of the renewable energy may include providing the renewable energy to the RES for each energy transaction message by listing up the amount of energy distribution for utility optimization trade.

The providing of the renewable energy may include purchasing insufficient energy according to a demand resource and supply of the RES from an electricity trading market, and providing at least one type of the renewable energy of the required energy and the insufficient energy to the RES at the time of trading.

The energy distribution management method may further include providing an incentive corresponding to contribution to energy provision of the REP as the energy trade is established.

According to another aspect, an energy distribution management method may including receiving an energy transaction message for insufficient energy according to a demand resource and supply of an RES in uncertain supply and demand for renewable energy, purchasing a required amount of energy corresponding to the insufficient energy from an electricity market based on the energy transaction message, performing energy trade with the RES according to a dynamic price and demand for renewable energy based on each time slot of a time unit, and when the energy trade with the RES is established, providing the renewable energy according to the required amount of energy purchased from the electricity market at the time of trading.

The receiving of the energy transaction message may include receiving the energy transaction message for being supplied with the insufficient energy of surplus energy of the demand resource in consideration of a ratio between power generation and demand for the demand resource of the RES.

The purchasing of the required amount of energy may include purchasing the required amount of energy corresponding to the insufficient energy through the electricity market at a dynamic price for each time period until a prerequisite regarding supply and demand is satisfied.

The performing of the energy trade may include performing the energy trade by adjusting the time of trading for each peak time period regarding the demand resource of the RES based on each time slot of the time unit.

The providing of the renewable energy may include providing at least one type of the renewable energy of the required energy and the insufficient energy to the RES at the time of trading.

According to another aspect, there is provided an energy brokerage apparatus for executing an energy distribution management method including a processor, and the processor is configured to receive an energy transaction message regarding required energy from an RES and profile the energy transaction message as history information, determine an amount of energy distribution distributable for each energy transaction message requesting required energy by analyzing the profiled history information, determine a brokerage fee for an energy trade between an REP and the RES according to the amount of energy distribution, when the energy trade is established at the brokerage fee, provide renewable energy to the RES by interconnecting the REP at the time of trading, and provide an incentive corresponding to contribution to energy provision of the REP as the energy trade is established.

The processor may be configured to analyze the energy transaction message from the RES to profile priority regarding supply of the renewable energy as the history information.

The processor may be configured to determine the amount of energy distribution corresponding to the energy transaction message regarding a demand resource and a load for each RES.

The processor may be configured to determine an amount of energy generation of the REP using generation information of distributed energy resources registered in the energy brokerage apparatus, and determine the distributable amount of energy distribution by comparing the amount of energy generation of the REP with an energy demand in the energy transaction message.

The processor may be configured to determine the brokerage fee for trading the required energy based on a usage amount of renewable energy consumed in each time slot of of a time unit.

The processor may be configured to purchase insufficient energy according to a demand resource and supply of the RES from an electricity trading market, and provide at least one type of the renewable energy of the required energy and the insufficient energy to the RES at the time of trading.

Additional aspects of example embodiments will be set forth in part in the description which follows and, in part, will be apparent from the description, or may be learned by practice of the disclosure.

According to an energy distribution management method of example embodiments, it is possible to deliver renewable energy optimized for distributed energy resources to be used by a demand resource and a load under an uncertain environment for new and renewable energy among renewable energy prosumers.

According to an energy distribution management method of example embodiments, it is possible to secure utility enhancement of renewable energy consumers, an increase in profits, and optimal profits in the brokerage of energy brokers by optimally distributing energy required by renewable energy consumers, through utility optimization trade using the time slot in the supply and demand for renewable energy due to the uncertainty when requesting the required energy from the renewable energy consumer to the renewable energy provider.

According to an energy distribution management method of example embodiments, it is possible to efficiently utilize available distributed energy resources by providing incentives to the renewable energy providers and ensure the stability in the supply and demand for distributed energy resources.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a dynamic brokerage system for utility optimization trade in uncertain supply and demand for renewable energy according to an example embodiment;

FIG. 2 is a diagram illustrating a detailed operation for dynamic brokerage of renewable energy of a dynamic brokerage system according to an example embodiment;

FIG. 3 is a graph illustrating a trade profit relationship according to utility optimization trade of an energy broker according to an example embodiment;

FIG. 4 is a flowchart illustrating an energy distribution management method of a dynamic brokerage system according to an example embodiment; and

FIG. 5 is a diagram illustrating an energy distribution management method of an energy brokerage apparatus according to an example embodiment.

### DETAILED DESCRIPTION

Hereinafter, example embodiments of the present disclosure will be described in detail with reference to the accompanying drawings.

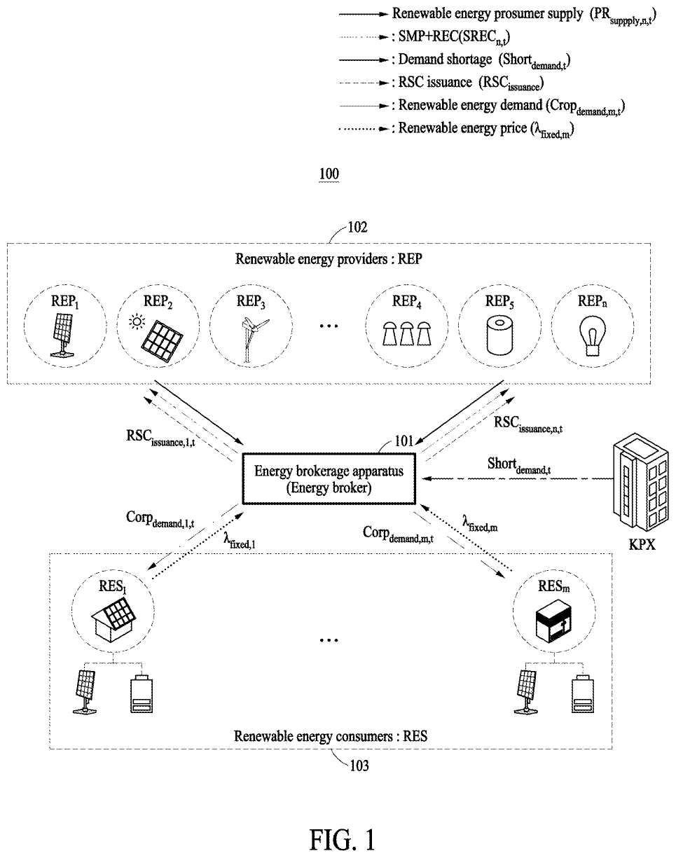

FIG. 1 is a diagram illustrating a dynamic brokerage system for utility optimization trade in uncertain supply and demand for renewable energy according to an example embodiment.

Referring to FIG. 1, the dynamic brokerage system may execute an energy distribution management method of dynamic brokerage for time slot-based utility optimization trade based on time in the uncertain supply and demand for renewable energy. To this end, the dynamic brokerage system may include an energy brokerage apparatus 101, a renewable energy provider 102, and a renewable energy consumer 103.

The renewable energy provider 102 may generate and register renewable energy by using available distributed energy resources, and analyze demand required from companies and overall demand pattern. The renewable energy provider 102 may estimate a required amount of RSC and calculate available supply and a volume of RSC issuance to bid in an RSC auction.

The renewable energy consumer 103 may request required energy for an insufficient amount, while self-consuming surplus energy of demand resource and also wishing to use the distributed energy resources. The distributed energy resources may provide renewable energy to the renewable energy consumers.

The energy brokerage apparatus 101 may utilize distributed energy resources which provide the renewable energy generated by the distributed energy resources from the renewable energy provider 102 and the self-consumed volume of RSC issuance to the auction. When a shortage occurs in the required energy, according to an energy transaction message from the renewable energy consumer 103, the energy brokerage apparatus 101 may manage energy brokerage distribution for the utility optimization trade depending on the energy by purchasing an amount equivalent to a required amount of insufficient energy in an electricity market. The energy brokerage apparatus 101 may provide the distributed energy resources, the real-time consumption of the required energy, and a demand resource and load of consumers who consume energy by storing surplus energy.

The renewable energy provider 102 may request registration of the distributed energy resources to the energy brokerage apparatus 101. The energy brokerage apparatus 101 may manage the distributed energy resources to be available by registering the distributed energy resources at the request of the renewable energy provider 102.

When receiving a request from the renewable energy consumer 103 for delivery of the required energy, the energy brokerage apparatus 101 may evaluate an energy transaction message regarding the required energy. In other words, the energy brokerage apparatus 101 may store and analyze history information on priority related to supply by profiling the history information using the energy transaction message.

The energy brokerage apparatus 101 may analyze the profiled history information to determine an amount of energy distribution distributable for each energy transaction message requesting required energy. In other words, when the analysis of the history information is completed, the energy brokerage apparatus 101 may calculate an amount of energy distribution for each energy transaction message according to the demand resource and load for each renewable energy consumer requesting required energy. Accordingly, the energy brokerage apparatus 101 may calculate and present the energy to be distributed to the renewable energy consumer 103 in accordance with the required amount of energy.

The energy brokerage apparatus 101 may be provided with a function to derive a profit by additionally purchasing and selling the insufficient energy of the renewable energy consumer 103 in the electricity market. In addition, the energy brokerage apparatus 101 may categorize the energy demand and surplus degree of the demand resource and load for energy distribution and trade of the distributed energy resources based on the time slot of a time unit when requesting energy. The energy brokerage apparatus 101 may be provided with a real-time energy supply and trading function.

In addition, the energy brokerage apparatus may list up available distributed energy resources and the amount of energy distribution for utility optimization trade so as to request insufficient energy from surplus energy of demand resources possessed by the renewable energy consumer. The energy brokerage apparatus may provide selling of renewable energy by establishing contracts with the renewable energy consumer for each energy transaction message from the renewable energy consumer.

Based on this, the energy brokerage apparatus 101 may provide renewable energy to the renewable energy consumer for each request of energy, and profit may be derived by purchasing and selling the insufficient energy. In addition, an incentive due to the provision of renewable energy may be provided to the renewable energy provider who has supplied renewable energy.

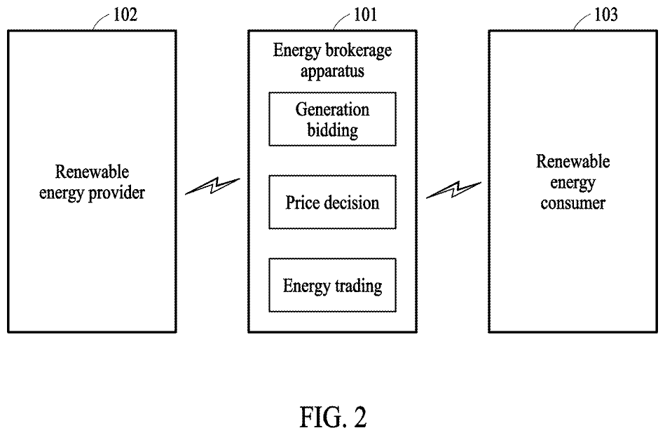

FIG. 2 is a diagram illustrating a detailed operation for dynamic brokerage of renewable energy of a dynamic brokerage system according to an example embodiment.

Referring to FIG. 2, an energy brokerage apparatus aims to maximize the sum of utility of renewable energy consumers, which is service fees for all RE100 consumers, under the concept of benefit in terms of utility optimization trade.

From this point of view, U(x_{i,k}^{s}) may refer to the total summation of the service fee of Consumer_{i,k}, the bidding cost for the total RSC issuance of the prosumer, an available supply cost of prosumer, and an insufficient service fee of the required amount of demand purchased from the grid. U(x) may refer to the optimal RSC brokerage profit of the energy brokerage apparatus in the energy distribution management method proposed in the present disclosure. The description above may be expressed as Equation 1 below.

U(x)=Σ_{i∈N,k∈K}U(x_{i,k}^{s}) [Equation 1]

Referring to Equation 1, it may be considered as optimization to derive optimal profits through utility enhancement according to the demand resource and load for all consumers.

According to Equation 1, the energy brokerage apparatus does not allocate more energy than the required amount, and the sum of all allocated energy cannot exceed the remaining amount from all renewable energy providers. To this end, U(x_{i,k}^{s}) may define the utility-based RSC brokerage profit of Consumer_{i,k} from the perspective of the dynamic brokerage system. U(x_{i,k}^{s}) may define the following assumptions and meaning thereof.

Specifically, U(x_{i,k}^{s}) may refer to a nonnegative real-valued function and may be an increasing function of x_{i,k}^{s} and a concave function of x_{i,k}^{s}. In addition, a quadratic utility function may be generally used for measuring a user's utility using the characteristics of the demand resource. This may be expressed as Equation 2 below.

U(x_{i,k}^{s})=λ_{fixed}*Corp_{demand,k}−λ_{pr,i,k}^{s}*RSC_{issuance,i,k}*x_{i,k}^{s}−PR_{supply,i,k}*(λ_{REC,k}+λ_{SMP,k})−Short_{demand,k}*λ_{SMP,k} [Equation 2]

Referring to Equation 2, from the perspective of the dynamic brokerage system, it may be considered as a function of utility-based RSC brokerage profits of Consumer_{i,k}. However, K={1, 2, . . . , N} may be a time index set of all renewable energy consumers. x_{i,k}^{s} may be the amount of energy consumed in the k^{th} time slot of the i^{th} consumer in the s^{th} scenario. Therefore, the energy distribution policy for the energy trade according to the dynamic price and demand for renewable energy based on the time slot may be expressed as Equation 3 below.

$${maximize}_{x} ( ( [ \frac{1}{\vert S \vert} ] ) * {\sum }_{s ∈ S} {\sum }_{t ∈ T} ( \begin{matrix}{λ}_{fixed} * {Corp}_{demand , t} - {λ}_{pr , n , t}^{s} * {RSC}_{issuance , n , t} * {x}_{n , t}^{s} \\ - {PR}_{supply , n , t} * ( {λ}_{REC , t} + {λ}_{SMP , t} ) - {Short}_{demand , t} * {λ}_{SMP , t}\end{matrix} ) ) \qquad [ Equation 3 ]$$

$$subject to$$

$${\sum }_{s ∈ S} {\sum }_{t ∈ T} {RSC}_{issuance , n , t} * {x}_{n , t}^{s} = {\sum }_{t ∈ T} {RSC}_{demand , t}$$

$${\sum }_{s ∈ S} {\sum }_{t ∈ T} {RSC}_{issuance , n , t} * {x}_{n , t}^{s} \leq {\sum }_{t ∈ T} {\sum }_{n ∈ N} {RSC}_{issuance , n , t}$$

However, λ_{fixed} may be a service fee paid by the RE100 consumer, and Corp_{demand,t} may be a demand from the RE100 consumer over time t. In addition, λ_{pr,n,t}^{s} refers to the RSC bidding cost of n prosumers. RSC_{issuance,n,t} is the volume of RSC issuance of n prosumers over time t. x_{n,t}^{s} may represent a binary decision variable, i.e., success or failure in the bidding.

Further, PR_{supply,n,t} refers to the suppliable capacity by n prosumers over time t. λ_{REC,t} refers to the existing REC price in accordance with time t, and λ_{SMP,t} refers to an electricity wholesale market price over time t. Short_{demand,t} may represent deficiency in the required amount of demand over time t, i.e., an amount of complementary supply. The constraint is that the total volume of RSC issuance of n prosumers in accordance with time t for success or failure in the bidding must be equal to the total RSC demand of the RE100 consumers in accordance with time t. In addition, the total volume of RSC issuance of n prosumers over time t for success or failure in the bidding must be less than or equal to the total volume of RSC issuance of n prosumers over time t.

In other words, the benefit of utility optimization trade may be derived from the standpoint of a broker if the bidding cost for the total volume of RSC issuance of n prosumers, the insufficient service fee for the required amount of demand purchased from the grid, and the available supply cost by n prosumers are eliminated from the service fee of the RE100 consumers.

Thus, the service fee of the RE100 consumers refers to the profit of the broker who sells the service to consumers, and the bidding cost for the total volume of the RSC issuance of n prosumers refers to the fee for the broker who purchases RSC from the prosumers. The insufficient service fee for the required amount of demand purchased from the grid refers to the fee for the broker who purchases the required amount of consumer's demand from an electricity exchange, and the available supply cost of n prosumers refers to the fee for the broker who purchases renewable energy from the prosumer.

In other words, since the objective function is concave and the constraints are linear, Equation 4 below may be given under the condition of the Lagrangian and duality. Since the objective function and the inequality constraint function are differentiable and convex while the equality constraint function is affine, an optimal solution may be obtained.

$$ℒ ( x , v , o ) = ( ( [ \frac{1}{\vert S \vert} ] ) * {\sum }_{s ∈ S} {\sum }_{t ∈ T} ( \begin{matrix}{λ}_{fixed} * {Corp}_{demand , t} - {λ}_{pr , n , t}^{s} * {RSC}_{issuance , n , t} * {x}_{n , t}^{s} \\ - {PR}_{supply , n , t} * ( {λ}_{REC , t} + {λ}_{SMP , t} ) - {Short}_{demand , t} * {λ}_{SMP , t}\end{matrix} ) ) \qquad [ Equation 4 ]$$

$$- {\sum }_{t ∈ T} {v}_{t} ( {\sum }_{s ∈ S} {\sum }_{t ∈ T} {RSC}_{issuance , n , t} * {x}_{n , t}^{s} - {\sum }_{t ∈ T} {\sum }_{n ∈ N} {RSC}_{issuance , n , t} )$$

$$- {\sum }_{t ∈ T} {o}_{t} ( {\sum }_{s ∈ S} {\sum }_{t ∈ T} {RSC}_{issuance , n , t} * {x}_{n , t}^{s} - {\sum }_{t ∈ T} {RSC}_{demand , t} )$$

Accordingly, the optimal energy trade policy for may be x*{x_{i,k}^{s}*|i∈N, k∈K} may be determined based on the following Equation 5.

[symbol]

(v,o)=maxₓ [symbol] (x,v,o)

[symbol]

(v,o)=min_{v≥0,o} [symbol] (v,o) [Equation 5]

Referring to Equation 5, in the present disclosure, the objective function for maximizing the RSC brokerage profits may be simplified by Lagrangian, and the value of the Lagrangian maximization may be defined as [symbol] (v, o). Therefore, in the present disclosure, the constraint of the objective function and the inequality is differentiable and convex, and the equality constraint is affine to satisfy condition of duality. Thus, the minimum value of [symbol] (v, o) may be expressed as D(v, o). Therefore, this may be substituted by finding a value of D(v, o).

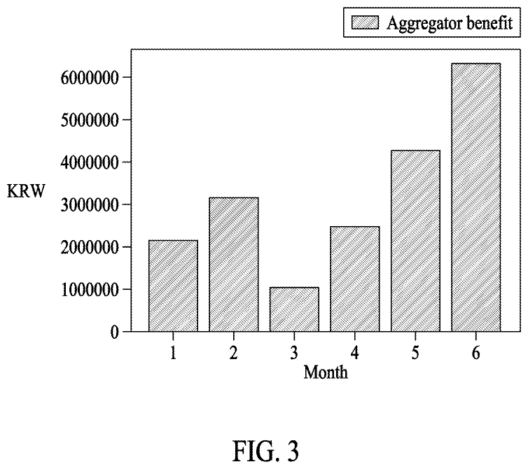

FIG. 3 is a graph illustrating a trade profit relationship according to utility optimization trade of an energy broker according to an example embodiment.

The dynamic brokerage system may improve the utility through optimal distribution of energy according to the required amount of energy demand from renewable energy consumers in the uncertain supply and demand for renewable energy when trading energy based on dynamic auction and demand.

The graph of FIG. 3 may represent a profit relationship in utility optimization trade of the broker for the energy trade based on dynamic auction and demand for renewable energy, for an optimal time slot-based utility optimization trade in the uncertain supply and demand for renewable energy.

In the case of the existing distributed energy resources, in supplying energy of the demand resource and load for the energy request per day, the renewable energy consumer is kept using the energy despite the surplus energy, or the renewable energy is supplied at a high price or the supply fails to be provided if the energy is insufficient.

Accordingly, the energy distribution management method proposed in the present disclosure may allocate the optimal brokerage according to the energy trade based on dynamic auction and demand for renewable energy using time slots in the uncertain supply and demand for renewable energy. In other words, when renewable energy is insufficient at the time of request for renewable energy during peak times or emergencies, the energy distribution management method may obtain profits in terms of the opportunity cost by (i) using the surplus energy of owned demand resource, (ii) purchasing energy at an economical price, or (iii) requesting energy demand equivalent to the insufficient amount of energy when energy is surplus. In addition, the energy distribution management method may improve satisfaction in the optimal energy brokerage distribution that may receive the optimal energy brokerage demand distribution from demand resources and loads.

In particular, the energy distribution management method ensures improved utility of renewable energy consumers when trading energy based on renewable energy dynamic auction and demand compared to the case when trading energy by brokerage based on the fixed auction and demand. Thus, from the perspective of renewable energy consumers who own the demand resources, it is possible to bring efficiency in energy utilization and enhancement in satisfaction.

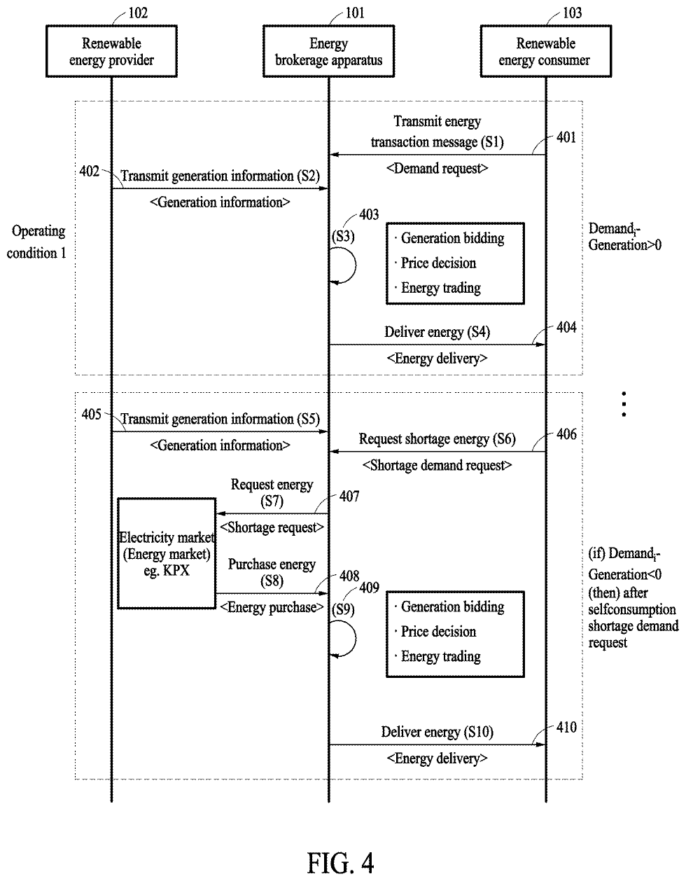

FIG. 4 is a flowchart illustrating an energy distribution management method of a dynamic brokerage system according to an example embodiment.

The flowchart in FIG. 4 shows each configuration diagram of the dynamic brokerage system for energy distribution management of the dynamic brokerage for the utility optimization trade based on the energy transaction message. The dynamic brokerage system may propose the utility optimization trade for renewable energy consumers who are sensitive to price in the uncertain supply and demand for renewable energy to optimize the benefit of renewable energy consumers.

The dynamic brokerage system may include the renewable energy consumer 103, the renewable energy provider 102, and the energy brokerage apparatus 101 for energy distribution management of the dynamic brokerage. At this point, the dynamic brokerage system may perform the utility optimization trade in consideration of operating conditions that satisfy a management mechanism for energy distribution of dynamic brokerage.

(i) Operating Condition 1

The dynamic brokerage system may perform the utility optimization trade when the operating condition 1 for energy distribution management of the dynamic brokerage according to Equation 6 below is satisfied.

Demandₜ−Generation>0 [Equation 6]

Equation 6 may indicate that the difference between demand and power generation is greater than ‘0’, representing a state in which the demand exceeds power generation.

S1 (401) is the case in which the demand from the renewable energy consumer 103 exceeds the power generation, satisfying the operating condition 1 of the management mechanism. The renewable energy consumer 103 may transmit an energy transaction message including the demand information of the renewable energy consumer 103 to the energy brokerage apparatus 101.

In S2 (402), the renewable energy provider 102 may transmit power generation information of the renewable energy provider 102 to the energy brokerage apparatus 101.

In S3 (403), the energy brokerage apparatus 101 may proceed generation bidding for the renewable energy consumer (103). In other words, the energy brokerage apparatus 101 may calculate an energy supply amount of the renewable energy provider 102 in response to the energy demand from the renewable energy consumer 103 based on the energy transaction message.

The energy brokerage apparatus 101 may determine the brokerage fee (price decision). In other words, the energy brokerage apparatus 101 may determine the brokerage fee in consideration of the bidding cost according to the volume of RSC issuance and the available supply cost of the prosumer. In this case, the price for the second-hand trade may be determined on an hourly basis. Here, the present disclosure may utilize a service fee model of the renewable energy consumer 103 to determine the brokerage fee. The service fee model of the renewable energy consumer 103 may be a model that determines the brokerage fee on an hourly basis in an auction type through bidding of goods according to supply and demand.

In the dynamic brokerage system, when the renewable energy provider 102 bids for the amount of energy generation and price for renewable energy, the renewable energy consumer 103 adjusts the energy demand according to the bid price, so that the brokerage fee and demand may be determined.

In S4 (404), when the energy trade is established at the brokerage fee, the energy brokerage apparatus 101 may provide renewable energy to the renewable energy consumer 102 by interconnecting the renewable energy provider 102 at the time of trading.

(ii) Operating Condition 2

The dynamic brokerage system may perform the utility optimization trade when the operating condition 2 for energy distribution management of the dynamic brokerage according to Equation 7 below is satisfied.

(if) Demandₜ−Generation<0

(then) after Self-Consumption

Shortage Demand Request [Equation 7]

Equation 7 indicates that the difference between the demand and power generation is less than ‘0’, representing a state in which power generation exceeds the demand. The type of renewable energy used by the renewable energy consumer 103 may be changed depending on whether the operating condition 2 is satisfied.

In S5 (405), the renewable energy provider 102 may transmit the generation information of the renewable energy provider 102 to the energy brokerage apparatus 101.

S6 (406) is the case that the power generation exceeds the demand from the renewable energy consumer 103, satisfying the operating condition 2 of the management mechanism. When the power generation exceeds the demand, the renewable energy consumer 103 self-consumes the renewable energy, and insufficient energy equivalent to an insufficient amount of energy may be transmitted to the energy brokerage apparatus 101.

The energy brokerage apparatus 101 may calculate required energy information between the amount of energy generation from renewable energy provider 102 and the energy demand for the insufficient energy.

In S7 (407)/S8 (408), the energy brokerage apparatus 101 may purchase the energy demand from the electricity market according to the required energy information. The energy brokerage apparatus 101 may additionally purchase shortage of the energy demand from the electricity market until the supply and demand are satisfied.

In S9 (409), the energy brokerage apparatus 101 may perform the same process (generation bidding, price decision, energy trading) as the series of processes proceeded in S3 (403). In other words, the energy brokerage apparatus 101 adjusts the energy demand from the renewable energy consumer 103 depending on the amount of energy generation and price bid by the renewable energy provider 102, thereby establishing energy trade between the renewable energy provider 102 and the renewable energy consumer 103 according to the brokerage fee.

In S10 (410), when the energy trade is established at the brokerage fee, the energy brokerage apparatus 101 may provide the renewable energy to the renewable energy consumer 102 by interconnecting the renewable energy provider 102 at the time of trading.

Therefore, the renewable energy consumer 103 may store the renewable energy during a non-peak period of the demand resource and may consume the renewable energy immediately when necessary. When surplus energy is generated, the renewable energy consumer 103 may optimize the profit by using the surplus energy during a peak period and being supplied with the insufficient required energy.

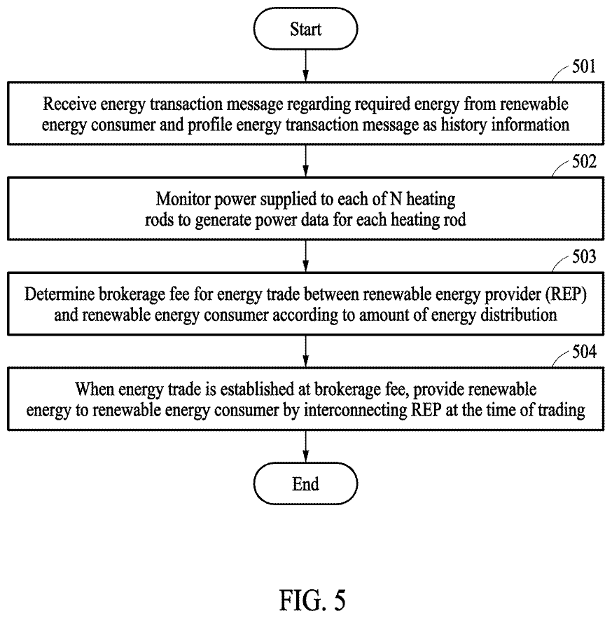

FIG. 5 is a diagram illustrating an energy distribution management method of an energy brokerage apparatus according to an example embodiment.

In operation 501, the energy brokerage apparatus may receive the energy transaction message regarding the required energy from the renewable energy consumer (RES) and profile the energy transaction message as history information. In other words, the energy brokerage apparatus may analyze the energy transaction message from the renewable energy consumer and profile the priority regarding the supply of renewable energy as history information.

In operation 502, the energy brokerage apparatus may analyze the profiled history information to determine the amount of energy distribution distributable for each energy transaction message for requesting the required energy. The energy brokerage apparatus may determine the amount of energy distribution corresponding to the energy transaction message regarding the demand resource and the load for each renewable energy consumer.

In addition, the energy brokerage apparatus may determine the amount of energy generation from the renewable energy provider by using the power generation information on the distributed energy resources registered in the energy brokerage apparatus. The energy brokerage apparatus may determine the distributable amount of energy distribution by comparing the amount of the energy generation from the renewable energy provider with the energy demand in the energy transaction message.

In operation 503, the energy brokerage apparatus may determine the brokerage fee for the energy trade between the renewable energy providers (REP) and the renewable energy consumer based on the amount of energy distribution. The energy brokerage apparatus may determine the brokerage fee in consideration of the bidding cost according to the volume of RSC issuance for the brokerage of renewable energy and the available supply cost of the prosumer. In addition, the energy brokerage apparatus may determine the brokerage fee for trading the required energy based on a usage amount of renewable energy consumed in each time slot of the time unit.

In operation 504, when the energy trade is established at the brokerage fee, the energy brokerage apparatus may provide the renewable energy to the renewable energy consumer by interconnecting the renewable energy provider at the time of trading. The energy brokerage apparatus may list-up the amount of energy distribution for the utility optimization trade to provide renewable energy to the renewable energy consumers for each energy transaction message.

The energy brokerage apparatus may purchase insufficient energy according to the demand resources and supply of renewable energy consumers from an electricity trading market. The energy brokerage apparatus may provide at least one type of renewable energy that is required or insufficient to the renewable energy consumer at the time of trading.

Here, the energy brokerage apparatus may receive an energy transaction message for insufficient energy according to the demand resource and supply from the renewable energy consumer in the uncertain supply and demand for renewable energy. The energy transaction message may include information for receiving insufficient energy in the surplus energy of the demand resource in consideration of the ratio between power generation and demand for the demand resource of the renewable energy consumer. For example, the renewable energy consumer may transmit, to the energy brokerage apparatus, the energy transaction message for requesting an insufficient amount of energy after self-consumption when power generation surpasses the demand.

The energy brokerage apparatus may purchase the required amount of energy corresponding to the insufficient energy from the electricity market based on the energy transaction message. The energy brokerage apparatus may additionally purchase an insufficient amount of required energy from the electricity market until the supply and demand according to the renewable energy consumers are satisfied. The energy brokerage apparatus may additionally provide renewable energy corresponding to the additionally purchased amount of required energy to the renewable energy consumer at a market price.

Here, the energy brokerage apparatus may trade energy by adjusting the time of trading for each peak time period regarding the demand resource of the renewable energy consumer based on each time slot of the time unit.

In operation 505, the energy brokerage apparatus may provide an incentive corresponding to contribution to energy provision of the renewable energy provider as the energy trade is established. The energy brokerage apparatus may provide the incentive to the renewable energy provider who has provided renewable energy, and provide profits to the renewable energy consumer for the consumption of surplus energy.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The methods according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made. The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

What is claimed is:

1. An energy distribution management method performed by an energy brokerage apparatus, the method comprising:
receiving an energy transaction message regarding required energy from a renewable energy consumer (RES) and profiling the energy transaction message as history information;
determining an amount of energy distribution distributable for each energy transaction message requesting required energy by analyzing the profiled history information;
determining a brokerage fee for an energy trade between a renewable energy provider (REP) and the RES according to the amount of energy distribution; and
when the energy trade is established at the brokerage fee, providing renewable energy to the RES by interconnecting the REP at the time of trading.

2. The method of claim 1, wherein the profiling as the history information comprises analyzing the energy transaction message from the RES to profile priority regarding supply of the renewable energy as the history information.

3. The method of claim 1, wherein the determining of the amount of energy distribution comprises determining the amount of energy distribution corresponding to the energy transaction message regarding a demand resource and a load for each RES.

4. The method of claim 1, wherein the determining of the amount of energy distribution comprises:
determining an amount of energy generation of the REP using generation information of distributed energy resources registered in the energy brokerage apparatus; and
determining the distributable amount of energy distribution by comparing the amount of energy generation of the REP with an energy demand in the energy transaction message.

5. The method of claim 1, wherein the determining of the brokerage fee comprises determining the brokerage fee in consideration of a bidding cost and an available supply cost of a prosumer according to a volume of issuance of renewable self-consumption credit (RSC) for brokerage of the renewable energy.

6. The method of claim 1, wherein the determining of the brokerage fee comprises determining the brokerage fee for trading the required energy based on a usage amount of renewable energy consumed in each time slot of a time unit.

7. The method of claim 1, wherein the providing of the renewable energy comprises providing the renewable energy to the RES for each energy transaction message by listing up the amount of energy distribution for utility optimization trade.

8. The method of claim 6, wherein the providing of the renewable energy comprises:
purchasing insufficient energy according to a demand resource and supply of the RES from an electricity trading market; and
providing at least one type of the renewable energy of the required energy and the insufficient energy to the RES at the time of trading.

9. The method of claim 1, further comprising:
providing an incentive corresponding to contribution to energy provision of the REP as the energy trade is established.

10. An energy distribution management method performed by an energy brokerage apparatus, the method comprising:
receiving an energy transaction message for insufficient energy according to a demand resource and supply of a renewable energy consumer (RES) in uncertain supply and demand for renewable energy;
purchasing a required amount of energy corresponding to the insufficient energy from an electricity market based on the energy transaction message;
performing energy trade with the RES according to a dynamic price and demand for renewable energy based on each time slot of a time unit; and
when the energy trade with the RES is established, providing the renewable energy according to the required amount of energy purchased from the electricity market at the time of trading.

11. The method of claim 10, wherein the receiving of the energy transaction message comprises receiving the energy transaction message for being supplied with the insufficient energy of surplus energy of the demand resource in consideration of a ratio between power generation and demand for the demand resource of the RES.

12. The method of claim 10, wherein the purchasing of the required amount of energy comprises purchasing the required amount of energy corresponding to the insufficient energy through the electricity market at a dynamic price for each time period until a prerequisite regarding supply and demand is satisfied.

13. The method of claim 10, wherein the performing of the energy trade comprises performing the energy trade by adjusting the time of trading for each peak time period regarding the demand resource of the RES based on each time slot of the time unit.

14. The method of claim 10, wherein the providing of the renewable energy comprises providing at least one type of the renewable energy of the required energy and the insufficient energy to the RES at the time of trading.

15. An energy brokerage apparatus for performing an energy distribution management method, the apparatus comprising:
a processor,
wherein the processor is configured to:
receive an energy transaction message regarding required energy from a renewable energy consumer (RES) and profile the energy transaction message as history information;
determine an amount of energy distribution distributable for each energy transaction message requesting required energy by analyzing the profiled history information;
determine a brokerage fee for an energy trade between a renewable energy provider (REP) and the RES according to the amount of energy distribution;
when the energy trade is established at the brokerage fee, provide renewable energy to the RES by interconnecting the REP at the time of trading; and
provide an incentive corresponding to contribution to energy provision of the REP as the energy trade is established.

16. The apparatus of claim 15, wherein the processor is configured to analyze the energy transaction message from the RES to profile priority regarding supply of the renewable energy as the history information.

17. The apparatus of claim 15, wherein the processor is configured to determine the amount of energy distribution corresponding to the energy transaction message regarding a demand resource and a load for each RES.

18. The apparatus of claim 15, wherein the processor is configured to:
determine an amount of energy generation of the REP using generation information of distributed energy resources registered in the energy brokerage apparatus; and
determine the distributable amount of energy distribution by comparing the amount of energy generation of the REP with an energy demand in the energy transaction message.

19. The apparatus of claim 15, wherein the processor is configured to determine the brokerage fee for trading the required energy based on a usage amount of renewable energy consumed in each time slot of a time unit.

20. The apparatus of claim 15, wherein the processor is configured to:
purchase insufficient energy according to a demand resource and supply of the RES from an electricity trading market; and
provide at least one type of the renewable energy of the required energy and the insufficient energy to the RES at the time of trading.
